(19) United States
(12) Patent Application Publication
(10) Pub. No.: US 2024/0023522 A1
(43) Pub. Date: Jan. 25, 2024

(54) Data Collection Device

(71) Applicant: Hill's Pet Nutrition, Inc., Topeka, KS (US)

(72) Inventors: Susan WERNIMONT, Lawrence, KS (US); Cheryl STIERS, Holton, KS (US); Janae Michelle BRADLEY, Topeka, KS (US); John Michael MCCOY, JR., Topeka, KS (US); Robin THOMPSON, Northumnerland (GB); Michael Edward MARINELLO, Highland Village, TX (US); Austin LUGINBILL, Manhattan, KS (US); Jose Mateus RAITZ PERSCH, Manhattan, KS (US); Kylie Wilkerson, Manhattan, KS (US); Aaron STORY, Manhattan, KS (US)

(73) Assignee: Hill's Pet Nutrition, Inc., Topeka, KS (US)

(21) Appl. No.: 18/358,596

(22) Filed: Jul. 25, 2023

Related U.S. Application Data
(60) Provisional application No. 63/392,002, filed on Jul. 25, 2022.

(51) Int. Cl. A01K 29/00; A01K 15/02; A61D 99/00

(52) U.S. Cl. CPC A01K 29/005; A01K 15/025; A61D 99/00

(57) ABSTRACT

A pet amusement device may comprise at least one housing that may comprise, a memory, a power source, a transceiver, and/or at least one sensor. The sensor may be configured to detect one or more parameters corresponding to at least one pet interaction with the device. The device may comprise a processor that may be configured to receive the one or more parameters. The processor may be configured to generate data corresponding to the one or more parameters. The processor may transmit one or more signals corresponding to the data to one or more remote servers. The device may comprise at least one haptic motor configured to generate at least some vibration through the at least one housing. The processor may be configured to control the at least some vibration based on an occurrence of a predetermined condition, or a command from the one or more remote servers.

### CROSS-REFERENCE TO RELATED APPLICATIONS

This application claims the benefit of priority from U.S. Provisional Application No. 63/392,002, filed Jul. 25, 2022, the contents of which are hereby incorporated herein by reference in their entirety, for all purposes.

### BACKGROUND

Animal/pet toys come in various forms that may or may not be specifically intended for animals (e.g., pets and/or animal companions) to play with. Some toys come in many varieties, such as bones, balls, tug toys, squeaky toys, discs, plush toys, and sticks.

Animal toys may serve different purposes, such as to assist teething, motivate exercise, provide mental stimulation, etc. Some animal toys may promote animal health, such as dental health. Many individuals all over the world have pets or companion animals that they care about. Animals and humans, for the most part, do not have the ability to effectively communicate the pet's current health, or health-related information to a pet caregiver and/or a veterinarian.

### BRIEF SUMMARY

The present disclosure may describe a pet amusement device (e.g., a toy) that includes a first housing enclosing at least in part a processor, a memory, a power source, and at least one sensor. The at least one sensor may be configured to generate data regarding a parameter related to a pet's health, behavior and/or habits, including use of the pet amusement device (e.g., toy). The device may comprise a transmitter configured to transmit the sensor data, or a derivative thereof.

A pet amusement device may comprise at least one housing. The at least one housing may comprise, a memory (e.g., a memory storage device), a power source, a transceiver, and/or at least one sensor. The at least one sensor may be configured to detect one or more parameters corresponding to at least one pet interaction with the device. The device may comprise a processor. The processor may be configured to receive the one or more parameters. The processor may be configured to generate data corresponding to the one or more parameters. The processor may be configured to transmit one or more signals corresponding to the data to one or more remote servers and/or wireless devices (e.g., smartphones).

The device may comprise at least one haptic motor configured to generate at least some vibration through the at least one housing. The processor may be configured to control the at least some vibration based on an occurrence of a predetermined condition, or a command from the one or more remote servers and/or wireless devices (e.g., smartphones).

The at least one sensor may comprise a camera configured to perform ultra-violet (UV) light spectroscopy on the pet. The camera may have a memory to support facial recognition of the pet and/or video recording of the inside of the pet's mouth and/or the pet's movements. One or more cameras could be RGB, black and white, thermal, or infrared, for example. The at least one sensor may comprise an amperometric hydrogen sulfide sensor configured to detect a halitosis condition in the pet. The at least one sensor may comprise a pressure sensor, and/or a temperature sensor.

The at least one housing may comprise a water-resistant rubber, and/or a rubber-like material, silicon, and/or soft plastic. The at least one sensor may comprise an accelerometer, a gyroscope, a proximity beacon, a pH meter, and/or a pressure or force sensor. The at least one housing may comprise a clock, a Wi-Fi™ antenna, a cellular antenna, and/or a Bluetooth™ antenna. The at least one house may comprise a sub-GHz radio to support low power wide area network (LPWAN) communications, and/or components to support low power mesh network communication protocols such as Zigbee, and/or an RFID chip.

The at least one pet interaction may comprise play with the device, a breathing on the device, a vocalization proximate to the device, a proximity to the device, a contact with the device, and/or one or more bites on the device. For example, a pet could be near the device without being in physical contact with the device. The pet may have wearable device or a RFID from a chip implanted in the pet to interact with the amusement device and indicate proximity.

The processor may be configured to process the data from the at least one sensor with one or more algorithms and/or models stored in the memory to determine a time of one or more interactions, a frequency of one or more interactions, a duration of one or more interactions, a type of one or more interactions, a bite force of one or more interactions, a bite evenness of one or more interactions, a pH of the pet, blood health of the pet, a temperature of the pet, oral health of the pet, cognitive health of the pet, emotional health or well-being of the pet, a behavior of the pet, a life stage of the pet, seasonality or circadian rhythms of the pet, a location of the one or more interactions, excessive movement or vocal whining of the pet, at least one unique characteristic of the one or more interactions, a presence of saliva, and/or an identity of the pet. The processor may be configured to consolidate and/or transform the data before it is transmitted.

The processor may be configured to generate the data from the at least one sensor such that the one or more remote servers and/or wireless devices (e.g., smartphones) may process the data with one or more algorithms and/or models stored in a server memory to determine a time of one or more interactions, a frequency of one or more interactions, a duration of one or more interactions, a type of one or more interactions, a bite force of one or more interactions, a bite evenness of one or more interactions, a pH of the pet, blood health of the pet, a temperature of the pet, oral health of the pet, cognitive health of the pet, emotional health or well-being of the pet, a behavior of the pet, a life stage of the pet, seasonality or circadian rhythms of the pet, a location of the one or more interactions, excessive movement or vocal whining of the pet, at least one unique characteristic of the one or more interactions, a presence of saliva, and/or an identity of the pet. The processor may be configured to consolidate and/or transform the data before it is transmitted.

The at least one housing may be a first housing. The device may comprise a second housing. The second housing may be configured to couple to the first housing. The second housing may comprise a second sensor that is different from the at least one sensor, an antenna that is different from any antenna in the first housing, and/or other component that is different from the at least one sensor, antenna, or other component in the first housing.

The transceiver may be configured to wirelessly transmit the data to the one or more remote servers and/or other devices (e.g., smartphones, etc.). The device may comprise at least one charging port operably coupled to the power source. The device may comprise at least one data port operably coupled to the processor.

### BRIEF DESCRIPTION OF THE DRAWINGS

The present disclosure will become more fully understood from the detailed description and the accompanying drawings, wherein:

FIG. 1 is a block diagram illustrating an example amusement device communication network operable to control one or more parts of an amusement device communication system via one or more devices, such as an amusement device control device (ADCD) device, among other devices.

FIG. 2 depicts a block diagram of modular pet amusement device and constituent components of an amusement device.

FIG. 3 is an example flow diagram of at least one technique for capturing data corresponding to one or more subjects in a amusement device monitoring system.

FIG. 4 is a block diagram of a hardware configuration of an example device that may control one or more parts of a amusement device system/communication network, such as the ADCD device of FIG. 1.

FIG. 5 depicts a block diagram of modular pet amusement device and constituent components of an amusement device.

FIG. 6A illustrates an example of an internal disassembled shell of a pet amusement device.

FIG. 6B illustrates an example of an inner core with a disassembled “shell”, springs, and foam.

FIG. 7 is an example block diagram of components in the modular design of a pet amusement device.

FIG. 8A to FIG. 8E illustrate various views of an example pet amusement device.

FIG. 9A and FIG. 9B illustrate example views of an open inner/internal core displaying the protected PCB and one or more other electrical components of an amusement device.

FIG. 10A to FIG. 10E illustrate at least some details of a PCB of at least one example amusement device.

FIG. 11A to FIG. 11G illustrate at least some details of a PCB of at least one example amusement device.

FIG. 12A to FIG. 12E illustrate at least some details of a PCB of at least one example amusement device.

FIG. 13A to FIG. 13C illustrate example testing schemes for engagement and/or biteforce measurements for an amusement device.

FIG. 14 is an example characteristic illustrating testing weight/biteforce measurement signals for at least four (4) sensors in a test amusement device.

The drawings represent one or more aspects of the disclosure and do not limit the scope of invention.

### DETAILED DESCRIPTION

The following description of the preferred embodiment(s) is merely exemplary in nature and is in no way intended to limit the invention or inventions. The description of illustrative embodiments is intended to be read in connection with the accompanying drawings, which are to be considered part of the entire written description. In the description of the exemplary embodiments disclosed herein, any reference to direction or orientation is merely intended for convenience of description and is not intended in any way to limit the scope of the present inventions. Relative terms such as “lower,” “upper,” “horizontal,” “vertical,” “above,” “below,” “up,” “down,” “left,” “right,” “top,” “bottom,” “front” and “rear” as well as derivatives thereof (e.g., “horizontally,” “downwardly,” “upwardly,” etc.) should be construed to refer to the orientation as then described or as shown in the drawing under discussion. These relative terms are for convenience of description only and do not require a particular orientation unless explicitly indicated as such. Terms such as “attached,” “affixed,” “connected,” “coupled,” “interconnected,” “secured” and other similar terms refer to a relationship wherein structures are secured or attached to one another either directly or indirectly through intervening structures, as well as both movable or rigid attachments or relationships, unless expressly described otherwise. The discussion herein describes and illustrates some possible non-limiting combinations of features that may exist alone or in other combinations of features. Furthermore, as used herein, the term “or” is to be interpreted as a logical operator that results in true whenever one or more of its operands are true. Furthermore, as used herein, the phrase “based on” is to be interpreted as meaning “based at least in part on,” and therefore is not limited to the interpretation “based entirely on.”

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

In the following description, where block diagrams or circuits are shown and described, one of skill in the art will recognize that, for the sake of clarity, not all peripheral components or circuits are shown in the figures or described in the description. For example, common components such as memory devices and power sources may not be discussed herein, as their role would be easily understood by those of ordinary skill in the art. Further, the terms “couple” and “operably couple” can refer to a direct or indirect coupling of two components of a circuit.

Features of the present inventions may be implemented in software, hardware, firmware, or combinations thereof. The computer programs described herein are not limited to any particular embodiment, and may be implemented in an operating system, application program, foreground or background processes, driver, or any combination thereof. The computer programs may be executed on a single computer or server processor or multiple computer or server processors.

Processors described herein may be any central processing unit (CPU), microprocessor, micro-controller, computational, or programmable device or circuit configured for executing computer program instructions (e.g., code). Various processors may be embodied in computer and/or server hardware of any suitable type (e.g., desktop, laptop, notebook, tablets, cellular phones, etc.) and may include all the usual ancillary components necessary to form a functional data processing device including without limitation a bus, software and data storage such as volatile and non-volatile memory, input/output devices, graphical user interfaces (GUIs), removable data storage, and wired and/or wireless communication interface devices including Wi-Fi™, Bluetooth™, LAN, cellular, satellite, etc.

Computer-executable instructions or programs (e.g., software or code) and data described herein may be programmed into and tangibly embodied in a non-transitory computer-readable medium that is accessible to and retrievable by a respective processor as described herein which configures and directs the processor to perform the desired functions and processes by executing the instructions encoded in the medium. A device embodying a programmable processor configured to such non-transitory computer-executable instructions or programs may be referred to as a “programmable device”, or “device”, and multiple programmable devices in mutual communication may be referred to as a “programmable system.” It should be noted that non-transitory “computer-readable medium” as described herein may include, without limitation, any suitable volatile or non-volatile memory including random access memory (RAM) and various types thereof, read-only memory (ROM) and various types thereof, USB flash memory, and magnetic or optical data storage devices (e.g., internal/external hard disks, floppy discs, magnetic tape CD-ROM, DVD-ROM, optical disk, ZIP™ drive, Blu-ray disk, and others), which may be written to and/or read by a processor operably connected to the medium.

In certain embodiments, the present inventions may be embodied in the form of computer-implemented processes and apparatuses such as processor-based data processing and communication systems or computer systems for practicing those processes. The present inventions may also be embodied in the form of software or computer program code embodied in a non-transitory computer-readable storage medium, which when loaded into and executed by the data processing and communications systems or computer systems, the computer program code segments configure the processor to create specific logic circuits configured for implementing the processes.

Disclosed herein are aspects of a pet amusement device (e.g., toy) that may be a data collection instrument incorporating at least one sensor for detecting health conditions related to a pet's mental, physical, or oral health, or detection of conditions such as aging, periodontitis, or arthritis. Data regarding such conditions may complement veterinarian evaluations by providing a continuous and objective system for data collection in between veterinary visits. The data collected by the amusement device (e.g., toy) may be analyzed using algorithms and/or models developed for interpretation of the health-related data. Certain versions of the amusement device (e.g., toy) may incorporate features to provide soothing or calming for pets that experience anxiety. Certain versions of the amusement device (e.g., toy) may provide entertainment or distraction for the pet. Such features may promote pet health, enrich the pet's environment, and promote a prolonged and advanced pet-parent relationship. Improved pet toys that monitor pet health behavior, and/or habits, and/or promote pet wellbeing may be useful.

Some examples of features the amusement device (e.g., toy) may provide are as follows: collecting data (e.g., pet temperature over time); responding to the pet in some way (e.g., toy moves away from pet); battery-powered engagement (e.g., ball capable of moving on its own, laser pointer, ball launcher); cognitive challenges (e.g., have the pet solve a puzzle before getting a treat).

One or more, or multiple amusement device could be used in conjunction with each other, to measure the same type of data (e.g., oral health) in different ways (e.g., one toy measures oral pH, another toy measures bite force, and together they provide a composite picture of the animal's oral health). Multiple amusement devices could provide complementary information (e.g., one toy measures bite force, another toy measures movement and/or records the time of day that the movement occurs, and together they provide a composite picture of aging, etc.). An amusement device could measure oral pH and another amusement device could measure location in relation to the home and the two devices could provide totally different pieces of information about the pet in general (e.g., one toy provides information about oral health, another toy provides information about whether the pet is inside or outside, etc.).

The amusement device may communicate with a collar worn wearable or other environmental sensor such as a smart feeder to generate information about the pet and/or the pet's health. Pairing activity data from a wearable, plus timing and duration of play with the device could yield information about mobility. For example, a pet with limited mobility and/or no engagement with a toy might be in pain, whereas pet with high overall activity and high engagement with a toy could be an older animal with healthy joints/no pain, or may be a young animal such as a puppy, etc. A wearable device may provide information such as how much time an animal spends awake and of that, how much time the animal interacted with the amusement device as an indicator of mental stimulation, etc.

Different versions of the amusement device (e.g., toy) may be tailored to specific data collection or other goals. For example, a device may have a video camera, a temperature sensor, gyroscope, accelerometer, and Bluetooth™ beacon, play audio sounds, and primarily be intended to measure anxiety behaviors. Another embodiment may have a UV camera, force sensor, gyroscope, accelerometer, Bluetooth™ beacon, proximity sensing features, and/or pH meter and primarily be intended to measure oral health features. The sensors may include an accelerometer, gyroscope, thermometer/temperature sensor, camera, microphone, speaker, pressure sensor, proximity beacon, pH meter, clock, Wi-Fi™ and Bluetooth™ communication antennae, and sensors for detection of halitosis compounds including but not limited to hydrogen sulfide, methyl mercaptan and hydrogen disulfide (such a sensor might be a miniaturized amperometric hydrogen sulfide sensor, or a UV light for UV spectral detection/spectroscopy). It is understood that the features listed herein are not exhaustive, and that different features can be added or subtracted for a variety of combinations.

As used herein, a “sensor” may refer to any instrument configured to enable the capturing of data for a parameter related to the amusement device (e.g., toy) or to the pet using the amusement device (e.g., toy). Further, “data” or “sensor data” may refer to any type of data obtained from a sensor or based on data obtained from a sensor. Such data includes but is not limited to information extracted or derived from a sensor or sensor signal, or from an image-capturing device such as a camera, regardless of the form of the extracted information, and combinations thereof. Such data may be, for example, in the form of mathematical data (such as a formula which mathematically represents at least part of the sensor signal), analog data (such as the waveform of the sensor signal), and/or digital data (such as a representation of at least part of the sensor signal in a digital format). The data may include statistical features derived from the sensor signal. The data may include measurements such as intervals between sensor signals, duration of time over which sensor signals are captured, the time of day, calendar date, geographic location, etc. in which the sensor signals are captured and/or the timing of sensor signals in relation to the type of play or type of stimulus (e.g., such as a haptic signal) provided by the toy. Different data features may be useful for assessing different health conditions and/or measuring different types of behavior. Specific combinations of data/data features may be uniquely informative for a given behavior and/or health condition.

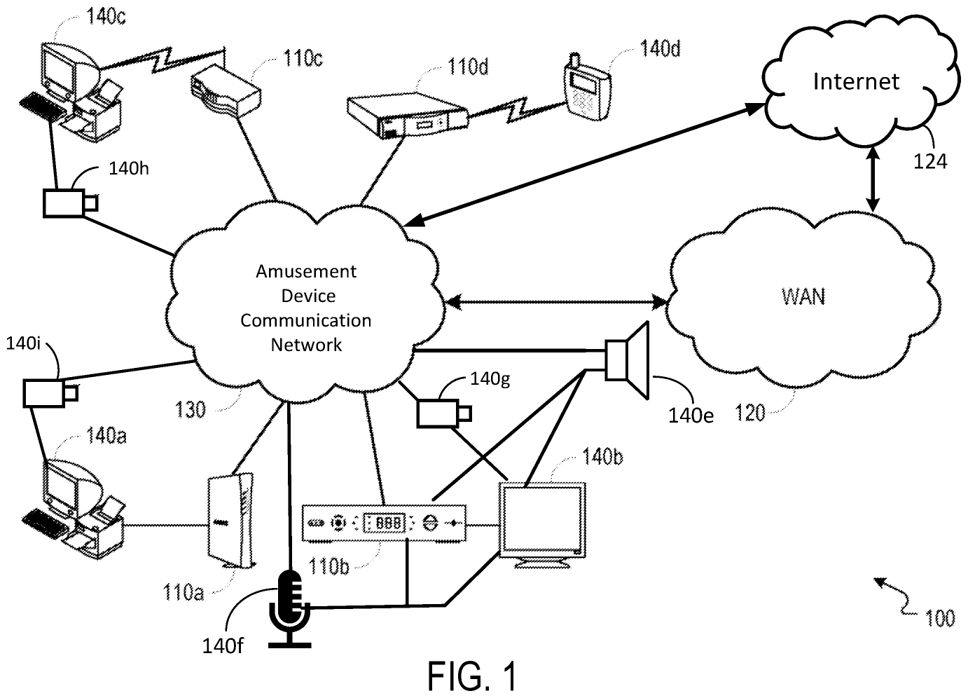

FIG. 1 is a block diagram illustrating an example Amusement Device Communication System Network (ADCSN) 100 operable to monitor and/or control one or more parts of an Amusement Device Monitoring System (ADMS). One or more of digital and/or analog control signals, electronic content, various input signals, and or various output signals, among other amusement device monitoring system information may be communicated from/across/among the Amusement Device Communication System Network 100. One or more of discrete control and/or continuous control schemes, techniques, and/or algorithms and/or models may be processed/performed by/across/from the Amusement Device Communication System Network 100.

Electronic content may include media content, electronic documents, device-to-device communications, streaming media content, digital image still frames, digital streaming video, Internet/cloud-based electronic applications/services/databases, electronic communications/services (e.g., video/audio conferencing), Internet-based electronic services, virtual reality content and/or services, augmented reality content and/or services, media captioning content and/or services, electronic commerce, video components/elements of electronic content, and/or audio components/elements of electronic content, among other types of electronic content.

In one or more scenarios, ADCSN devices 110a-d transmit/receive signals and/or communications and/or may receive data service(s) from a wide area network (WAN) 120 via a connection to an Amusement Device Communication Network (ADCN) 130. The one or more nodes of Amusement Device Communication Network 130 and/or the WAN 120 may communicate with one or more cloud-based nodes (not shown) via the Internet 124.

The ADCN devices can include, for example, a modem 110a, a process control device/logic controller 110b, a wireless router including an embedded modem 110c, or a media gateway 110d, among many others (e.g., digital subscriber line (DSL) modem, voice over internet protocol (VOIP) terminal adapter, video game console, digital versatile disc (DVD) player, communications device, hotspot device, etc.). The Amusement Device Communication Network 130, for example, can be a hybrid fiber-coaxial (HFC) network, a local area network (LAN), a wireless local area network (WLAN), a cellular network, and/or a personal area network (PAN), as well as others. As used herein, an Amusement Device Control Device (ADCD) may be any of the devices 110a-110d and/or 140a-140i, an Internet Gateway, a router device, a set-top box (STB), a process control device/logic controller, a smart media device (SMD), a cloud computing device, any type of ADCD, and/or any other suitable device (e.g., wired and/or wireless) that may be configured to perform one or more of the techniques and/or functionality disclosed herein, for example.

The ADCD devices can facilitate communications between the WAN 120 and devices 140a-140i. A cable modem or embedded MTA (eMTA) 110 a can facilitate communications between the WAN 120 and a computer 140a. A process control device/logic controller 110b can facilitate communications between the WAN 120 and a television/monitor/display 140b (e.g., a media presentation device, a graphical user interface, a process control interface, etc.) and/or a digital video recorder (DVR). A wireless router 110c can facilitate communications between a computer 140c and the WAN 120.

The media gateway 110d can facilitate communications between a mobile device 140d (e.g., a pet amusement device, a pet wearable device, a tablet computing device, a smartphone, a personal digital assistant (PDA) device, a laptop computing device, etc.; one or more devices being PC-based, iOS-based, Linux-based, and/or Android-based, etc.) and the WAN 120. One or more speaker devices (e.g., sound radiation devices/systems) 140e may be in communication with the Amusement Device Communication Network 130, process control device/logic controller 110b, and/or television/monitor/display 140b, etc. Camera devices 140g, 140h, and/or 140i may be in communication with the computer 140a, the television/display/monitor 140b, the computer 140c, and/or the Amusement Device Communication Network 130, for example, among other devices and networks.

The one or more speaker devices 140e (e.g., surround sound speakers, home theater speakers, other external wired/wireless speakers, loudspeakers, full-range drivers, subwoofers, woofers, mid-range drivers, tweeters, coaxial drivers, etc.) may broadcast at least an audio component of electronic content/media content, among other audio signals, processes, and/or applications. The one or more speaker devices 140e may possess the capability to radiate sound in pre-configured acoustical/physical patterns (e.g., a cone pattern, a directional pattern, etc.). For example, process control device/logic controller condition monitoring audible alarms may be communicated via one or more of the speaker devices 140e.

One or more microphone devices 140f may be external/standalone microphone devices. The one or more microphone devices 140f may be in communication with the Amusement Device Communication Network 130, process control device/logic controller 110b, television/display/monitor 140b, computer 140a, computer 140c, mobile device 140a, etc. Any of the devices 110a-110d and/or devices 140a-140i may include internal microphone devices. The one or more speaker devices 140e (e.g., “speakers”) and/or the one or more microphone devices 140f (e.g., “microphones”, that may be “high quality” devices such as far field microphones, noise-cancelling microphones, shotgun microphones, dynamic microphones, ribbon microphones, and/or various size diaphragm microphones, Bluetooth™_based remote/control devices, RF4CE-based remote/control devices, etc.) may have wired and/or wireless connections (e.g., Bluetooth™ Wi-Fi™, private protocol communication network, etc.) to any of the other devices 140a-140i, the Amusement Device Communication Network 130, the WAN 120, and/or the Internet 124.

The camera devices 140g-140i may provide digital video input/output capability for one or more of the devices 110a-110d and/or devices 140a-140d. The camera devices 140g-140i may communicate with any of the devices 110a-110d and/or devices 140a-140f, perhaps for example via a wired and/or wireless connection. One or more of the camera devices 140g-140i may capture digital images, digital video streams, and/or may scan images of various kinds, such as Universal Product Code (UPC) codes and/or Quick Response (QR) codes, for example, among other images. One or more of the camera devices 140g-140i may provide for video input/output for video monitoring (e.g., may serve as webcams or the like), for example, among other video functions.

Any of the camera devices 140g-140i may include microphone devices and/or speaker devices. The input/output of any of the camera devices 140g-140i may include audio signals/packets/components, perhaps for example separate/separable from, or in some (e.g., separable) combination with, the video signals/packets/components of any of the camera devices 140g-140i.

One or more of the camera devices 140g-140i may detect the presence of one or more subjects and/or things that may be proximate to the camera devices 140g-140i and/or that may be in the same general space (e.g., the same room, same space, same room, same delimited area, etc.) as the camera devices 140g-140i. One or more of the camera devices 140g-140i may gauge a general activity level (e.g., high activity, medium activity, and/or low activity) of one or more subjects that may be detected by the camera devices 140g-140i. One or more of the camera devices 140g-140i may detect one or more general characteristics (e.g., height, body shape, skin color, pulse, heart rate, breathing count, object size, object volume, object bulk, etc.) of the one or more subjects detected by the camera devices 140g-140i. One or more of the camera devices 140g-140i may be configured to recognize one or more specific subjects, for example. One or more of the camera devices 140g-140i may be configured to detect a subject's attention/gaze toward another subject (e.g., detecting a subject and/or object that may correspond to a subject's attention/gaze toward another subject or object, such as an amusement device).

One or more of the camera devices 140g-140i may be use wireless communication with any of the devices 110a-110d and/or 140a-140d, such as for example Bluetooth™ and/or Wi-Fi™ among other wireless communication protocols. One or more of the camera devices 140g-140i may be external to any of the devices 110a-110d and/or devices 140a-140d. One or more of the camera devices 140g-140i may be internal to any of the devices 110a-110d and/or devices 140a-140d.

One or more of the camera devices 140g-140i may be an industrial vision camera device. The vision camera may be a gigabit Ethernet compatible device (e.g., 10 GB Ethernet, or the like). The vision camera may function in black & white, infrared, and/or color. The vision camera may have a capacity of at least 8.8 megapixel, or the like. The vision camera may have a resolution of 4096×2160 pixel, or the like. For example, the vision camera may be a (e.g., manufactured by Baumer such as a VLXT-90C.I LX series, or like/equivalent or other device as mentioned herein) may capture product images in various forms such as digital still image frames and/or video streams, etc., perhaps for example from zero to ninety-five (95) frames per second (fps). The vision camera may have one or more parameters configurable remotely and/or locally. Lower resolution cameras may be suitable.

AMCD devices such as process control device/logic controller devices, media gateway devices, among others, may support visual and/or voice interface with users, viewers, and/or Amusement Device Communication Network 130 operators. This interface may support smart enhancement to the user/viewer/operator experience, for example in the amusement device communication network environment, or in any network environment. One or more traditional and/or current viewer experiences can be enriched to utilize visual and/or voice interface, perhaps for example to derive smart actions and/or results.

In one or more scenarios, any of the devices 110a-110d, 140a-140i, among other devices, may be used to implement any of the capabilities, techniques, methods, and/or devices described herein.

The WAN network 120 and/or the Amusement Device Communication Network 130 may be implemented as any type of wired and/or wireless network, including a local area network (LAN), a wide area network (WAN), a global network (the Internet), etc. Accordingly, the WAN network 120 and/or the Amusement Device Communication Network 130 may include one or more communicatively coupled network computing devices (not shown) for facilitating the flow and/or processing of network communication traffic via a series of wired and/or wireless interconnections. Such network computing devices may include, but are not limited, to one or more access points, routers, switches, servers, computing devices, and/or storage devices, etc.

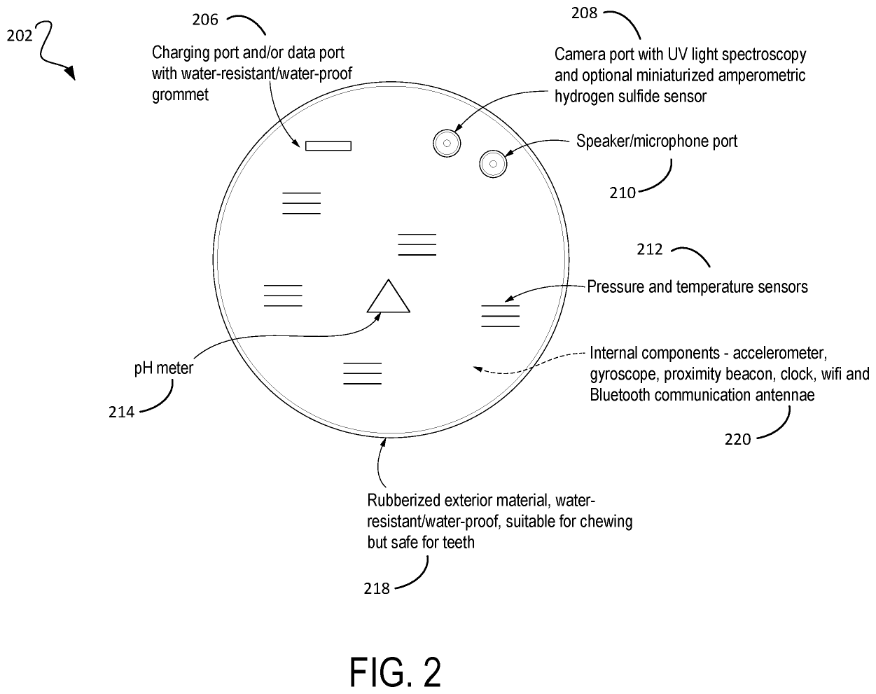

FIG. 2 is a block diagram of at least one amusement device (e.g., toy) 202. The device 202 may include a charging port and/or data port 206 (e.g., which may include a water-resistant or water-proof grommet), a camera port 208 for UV light spectroscopy (e.g., which may include a miniaturized amperometric hydrogen sulfide sensor), a speaker/microphone port 210, force, pressure and temperature sensors 212, a pH meter 214, an exterior material 218 (e.g., a rubberized, water-resistant material suitable for chewing but safe for teeth), and internal components 220 (e.g., an accelerometer, gyroscope, proximity beacon, clock, and Wi-Fi™ and Bluetooth™ communication antennas, and/or a rechargeable power source). It is understood that the features/elements listed herein are not exhaustive, and that different features/elements can be added, or subtracted, for a variety of combinations depending on the health state, parameter, behavior, and/or habit of interest.

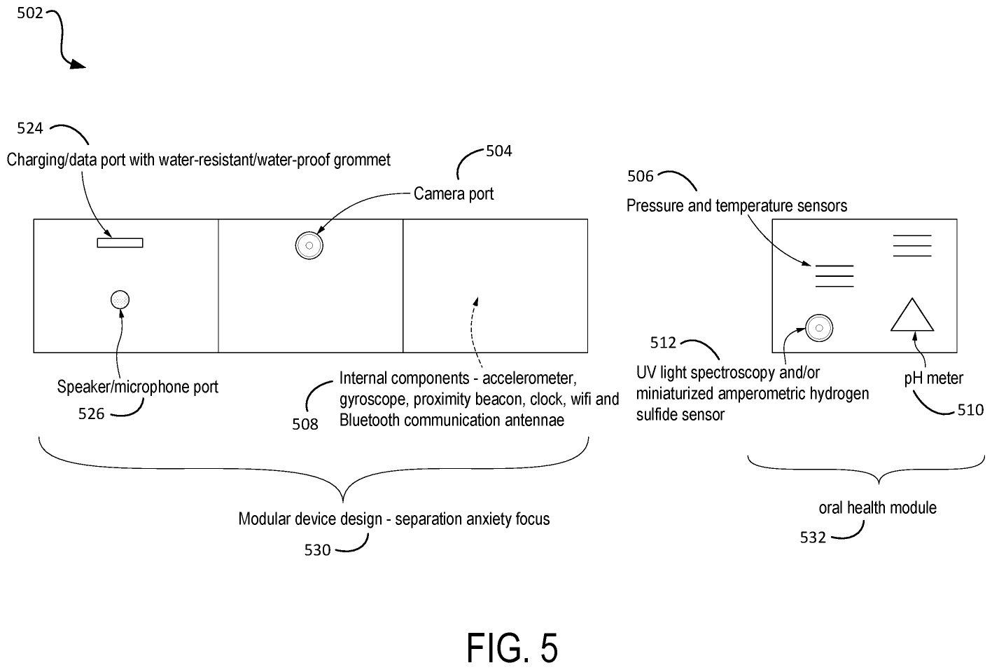

FIG. 5 shows at least one scenario of the modularity of the amusement device 502 (e.g., toy). In a modular embodiment, different components may be added to or removed from the amusement device 502 (e.g., toy) by the pet parent and/or researcher to change its appearance and/or capabilities. This may include, but is not restricted to the addition or removal of a charging and/or data port with water-resistant/water-proof grommet 524, a speaker/microphone port 526, a camera/port 504, a UV light spectroscopy and/or miniaturized amperometric hydrogen sulfide sensor 512, force and/or pressure and/or temperature sensor 506, internal components 508 such as gyroscope, accelerometer, Bluetooth™ beacon, proximity sensing features, a pH meter 510, etc. The amusement device 502 (e.g., toy) may have a variety of shapes (ball, bone, stuffed animal, block, etc., not shown) and sizes to be suitable for cats and dogs, and animals of different sizes. The modularity of the amusement device 502 may be considered for example in the modular section 530 that may include components that may focus on a pet's separation anxiety analysis. A modular section 532 may include components that may focus on a pet's oral health, for example. The sections 530 and/or 532 are examples and could be swapped out for various other sections/modules (not shown) to detect other behaviors/health states, for example.

The amount of time the animal/pet needs to be in contact or proximity to the amusement device (e.g., toy) to capture useful/adequate data may vary depending on the data being collected. The data collected by the amusement device (e.g., toy) may be analyzed using algorithms and/or models developed for interpretation of health-related data. Examples of various data endpoints that may be used in health-related algorithms and/or models are as follows: Time of play; Date of Play, Frequency of play; Duration of play; Type of play; Duration of time spent in proximity to the toy; Identification of which pet is playing with the toy; Bite force and/or pressure; Bite evenness; pH; UV light—blood; UV light or Hydrogen sulfide detector—measures hydrogen sulfide, methyl mercaptan and hydrogen disulfide; Proximity; Bluetooth™; Camera/microphone. These parameters, or derivatives thereof, may be used to evaluate a variety of health or behavior characteristics, for example as indicators of lifestage, development or aging; seasonality and/or circadian rhythms; physical, mental or emotional health, stamina or well-being; type, location or intensity of play; and/or the unique or identifying characteristics of the pet that is playing. Some parameters of play, such as type of play, bite force, timing of play, oral health parameters, etc., could be used to recognize which pet is engaging with toy. A camera for visual identification of the pet may be used to determine which pet is playing with the toy, perhaps in conjunction with, or independent of, a collar worn wearable that could be used to determine which pet is playing with the toy.

In addition to these health-related outcomes, the amusement device (e.g., toy) may also support training, developing skills, and/or pet-pet parent bonding. The amusement device (e.g., toy) may have an exterior that is durable and resistant to destruction, yet suitable for data collection instruments and not harmful to the pet's teeth. In a preferred embodiment, the amusement device (e.g., toy) is water-resistant or waterproof given that it may be chewed, dropped in water, etc. A rubberized and/or silicon and/or soft plastic material with ports for charging/battery insertion and audio/visual data capture, for example, may be used.

The materials used for the pet amusement device internal part may include nylon, carbon, silicone, soft plastic, and/or rubber—for being resilient when it comes to continuous applied stresses. For an external layer, a flexible filament, something flexible and thin may allow readings to come through without additional interference. These materials are also not damaging to the animal. An external part of the amusement device may include a shell.

In one or more scenarios, a foam pad(s) may lay on either side of the pressure sensor(s). To facilitate foam expanding and/or the shell being able to return to its original position, one or more small springs may be added underneath each shell. These springs may act to return the shells to their original shape, decompress the components, and/or maintain tightness between the shells and the external pet amusement device interface layer. The external shell may be soft, and/or flexible so as to absorb shock forces. This could be accomplished with a rubber, or other flexible material film.

It may be useful to develop a way of keeping the pet/animal from becoming bored of the amusement device (e.g., toy). In one or more scenarios, a modular attachments system could be used to vary the shape, the size, weight, and the texture of the toy. In this way, a (e.g., single) device could act as if it is many, and still supply reasonable data sets to be later used in determining health—something that has not been marketed in the pet industry.

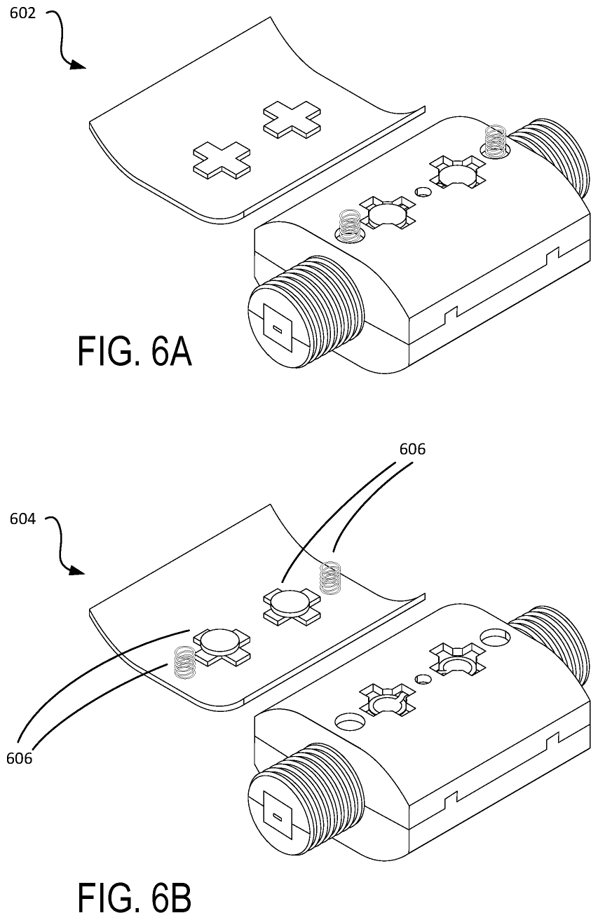

FIG. 6A illustrates an example of an internal disassembled shell 602 of a pet amusement device. FIG. 6B illustrates an inner core 604 with a disassembled “shell”—showing among other things springs and foam 606, etc.

The external shell may be soft and/or flexible so as to absorb shock forces. This could be accomplished with a rubber, or other flexible material film as described herein.

The shape of the amusement device may be able to disperse forces evenly across it, and/or may maintain a rigid base shape. This may occur with the oblong cylinder illustrated in FIG. 6A and FIG. 6B. The development of the internal layer may be manufactured in Nylon Carbon mesh filament, for example.

The amusement device may include a central core that may enclose the primary electrical components. This core may have two flat sides, with docking ports for add-ons. These add-ons may have their own connection ports and/or may be able to attach to one of the two sides to add length, texture, and/or shape variation to the total amusement device's physical appearance. In this way, the amusement device could even change its weight, become softer, or hard, and possibly even be an entirely new type of amusement device (e.g., toy).

Bluetooth Low Energy (BLE) is a low power wireless technology that supports Point to Point, Broadcast and Mesh topologies. In addition, the BLE protocol stack is widely supported. Connection to the Internet could relay the data from the BLE device to a server, or a gateway. Bluetooth Low Energy (BLE) may be used for the pet amusement device, for example due to it being a low energy solution for device communication. Other communication protocols may be used as described herein.

Regarding processors/microprocessors, a Nordic NRF52 series may be used, among other devices, as it is low power wireless SoC microcontrollers and supports Bluetooth™ Low Power. The Nordic microcontroller has its own built-in antenna, which may reduce the component complexity in design.

Regarding pressure sensors, a Force Resistive Sensor and/or a Piezo Electric Sensor may be used. At least four (4) circular pressure sensors may be used in the pet amusement device to represent at least four (4) different regions of the pet amusement device's surface.

In one or more scenarios, the pet amusement device may be a multi-layered and/or component pet toy, which may utilize modular connection systems to adapt its shape, size, and/or texture to prevent animal boredom, for example. The external texture layer may be a pet safe, durable, and/or soft silicon like surface meant for absorbing shock trauma and/or preventing any discomfort that could be caused by the much more tough interior layer. Between the internal and external layers lay a series of pressure resistive sensors that may send signals to the internal processing system based on the applied forces. The internal layer may be a stronger, much more force resistive material such as carbon fiber enhanced nylon filament. Internal to that may be an inertial measurement unit (IMU) and/or PCB design. The IMU may serve as a point in space and/or activity monitoring system. Signals sent by the IMU may be transferred to the microcontroller located on the PCB. The one or more microcontrollers may gather, assess, filter, and/or process the signals and/or may transfer the data (e.g., wirelessly through BLE) to an external storage bank and/or remote servers and/or wireless devices (e.g., smartphones) for further processing and/or interpretation.

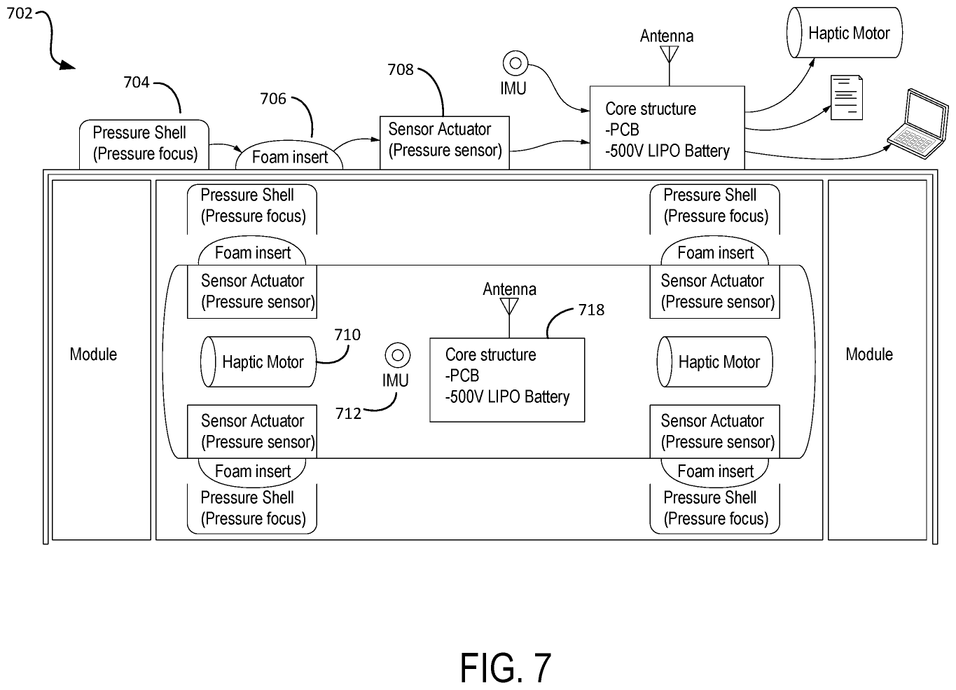

FIG. 7 is an example block diagram of components in the modular design of a pet amusement device 702. The device 702 may comprise, among other elements, one or more pressure shells 704, one or more foam inserts 706, one or more sensor actuators 708, one or more haptic motors 710, one or more IMUs 712, and/or an PCB 718 (e.g., located in core structure of the device 702). The PCB 718 may comprise a wireless microcontroller chip, a batter charger, an IMU, Haptic motor drivers, and/or a Bluetooth™ communication interface (not shown).

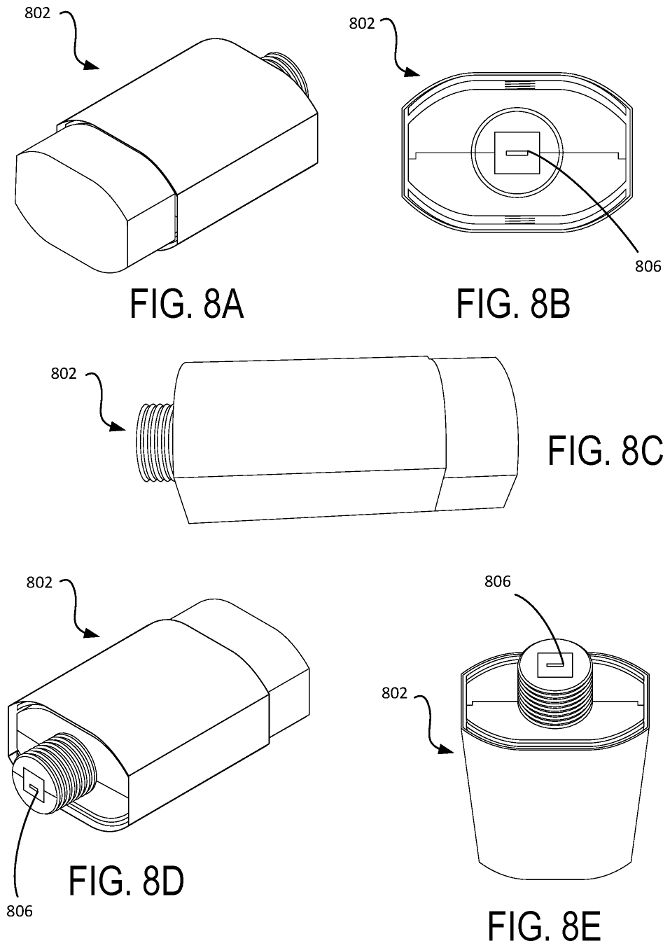

FIG. 8A-8E illustrates various views of an example pet amusement device 802. The device 802 may be a shape adjusting system, that may be comprised of module attachments, as well as a primary core, which may be the housing for the primary electrical components. An External Layer (shown) may be composed of a soft, malleable material for animal interface protection and shock resistance to the overall product, while also not significantly impacting pressure sensor readings. An Internal Layer (not shown) may be composed of a more rigid, stress resistant material to protect the internal electrical components, as well as maintaining structural stability and/or shape. The device 802 may have a female docking system (not shown) that may be attachable to the internal core component. The device 802 may have a male port (not shown) to attach the pressure sensors to the internal core's electrical systems. A removable cover 806 may provide access to the inner core of the device 802 (e.g., to access the PCB and other components).

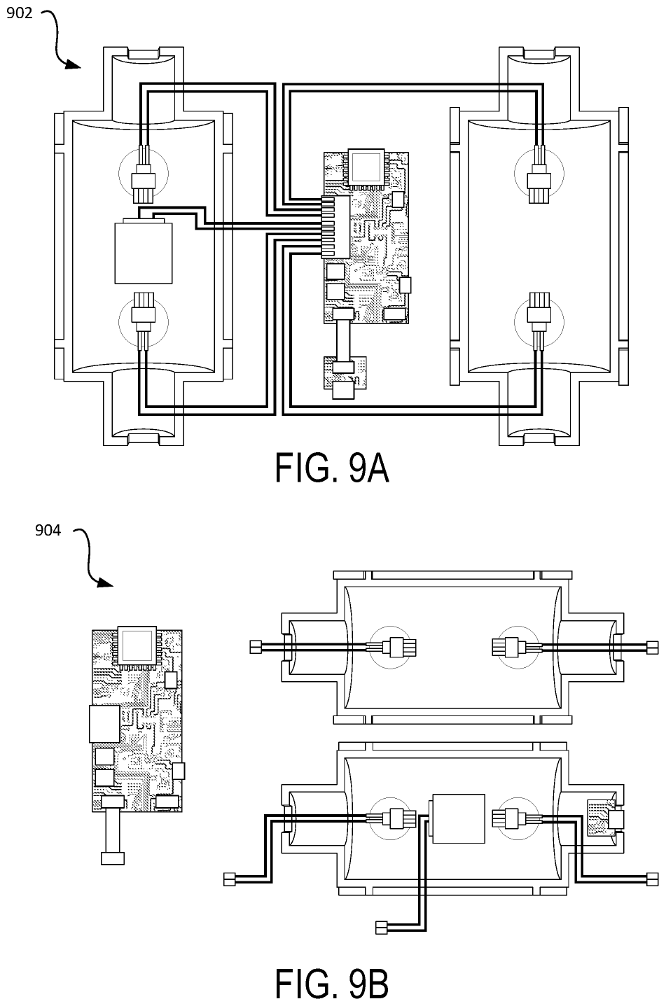

FIG. 9A and FIG. 9B illustrate example views 902 and 904 of an open inner/internal core displaying the protected PCB and one or more other electrical components. The internal core may comprise an external layer that may be the same as the module's external layer described herein. The internal core may comprise an Internal Layer that may have the same material makeup as the modules. The internal core may be the housing for the primary electrical components that perform data acquisition, interpretation, and/or data exportation. This may house the battery and may contain one or more pressure sensors between the internal and external layers (e.g., like the modules). Shells may be used to help focus pressure forces directly towards the force resistive sensors, perhaps for example padded by a thin layer of foam. The electrical system may include the module pressure sensors, its own pressure sensors, the PCB, and battery components, among other components, for example. The internal core may include female docking ports that may form a seamless connection to the modules. It may also contain female connection ports for connection to the module electronics and may have a port(s) for USB charging and/or data transfer.

One or more printed circuit boards (PCB) may contain the wireless SoC, IMU, battery management circuit, Haptic motor, flash memory, and/or an antenna(s) for various communication protocols may be routed directly to the PCB controller. The PCB may be small enough to fit into the core structure. The PCB may have connections for the pressure sensors, USB connector, and/or for the batteries, among numerous other devices.

A wireless SoC may be a microcontroller sampling data from the pressure sensors and may interface with the IMU, among other functions. It may transmit (e.g., short term) processed and/or relevant data. The SoC may hold the data in flash memory for a long term and/or temporarily. The IMU may comprise an accelerometer and/or a gyroscope embedded into a chip. It may output its data to the SoC through I2C and/or SPI protocols, among other protocols. Lithium-Polymer (LiPo) Batteries may be small enough to fit into the core and/or may have enough capacity to provide good autonomy for the amusement for the device.

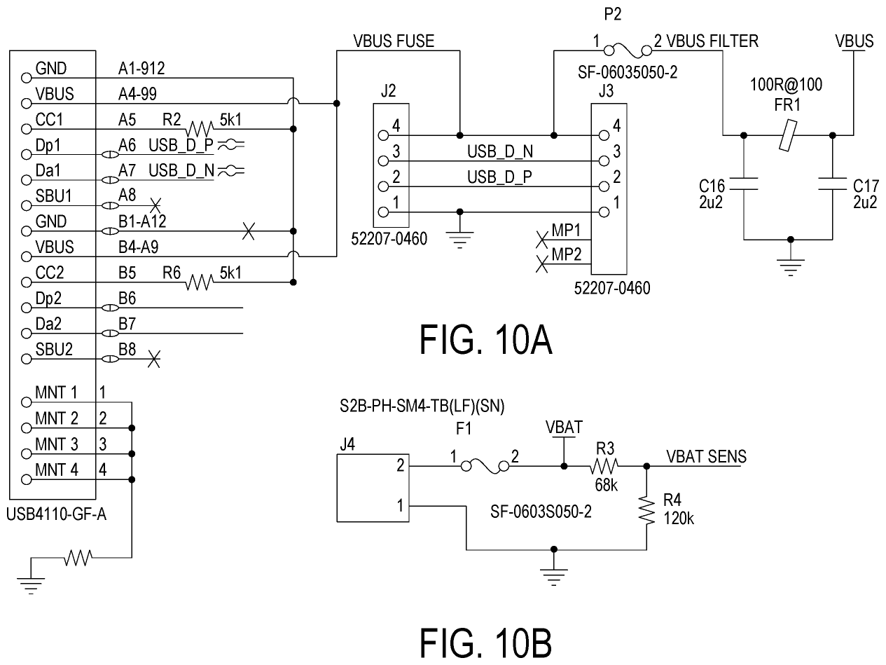

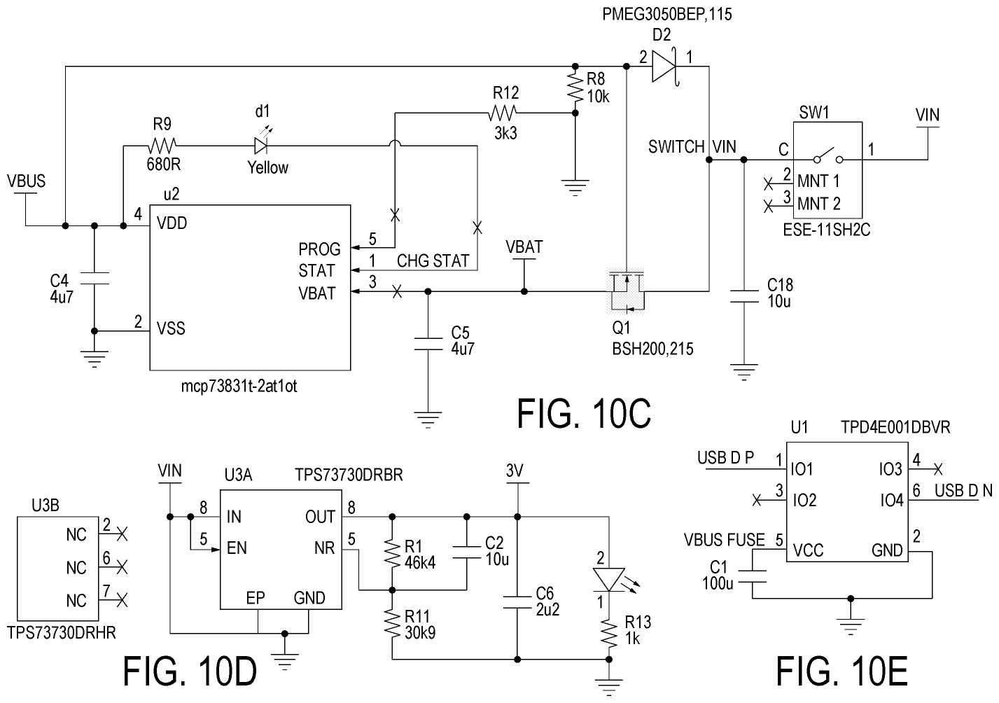

FIG. 10A to FIG. 10E illustrate at least some details of a PCB of at least one example amusement device.

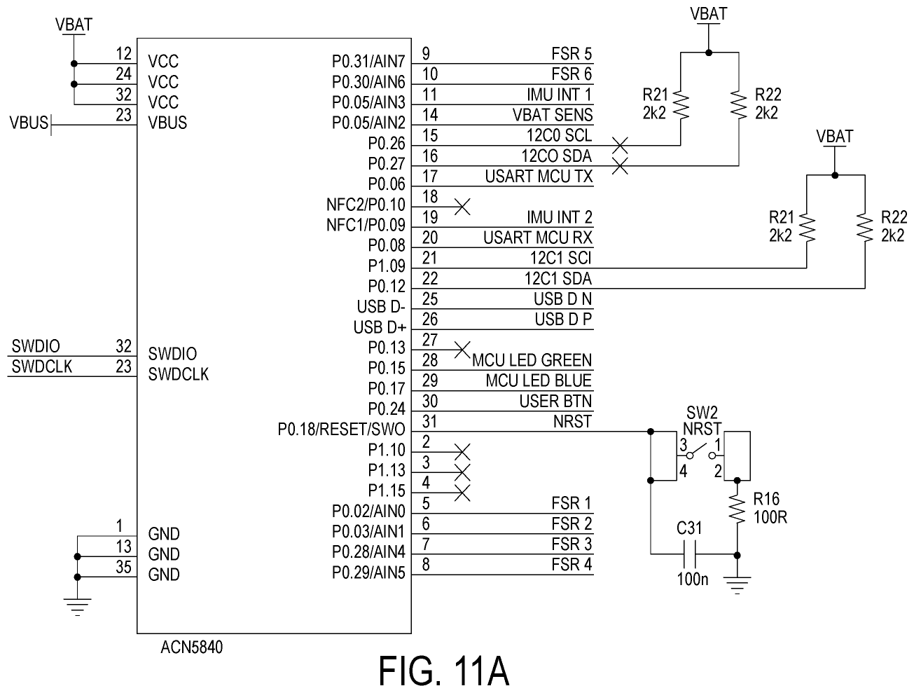

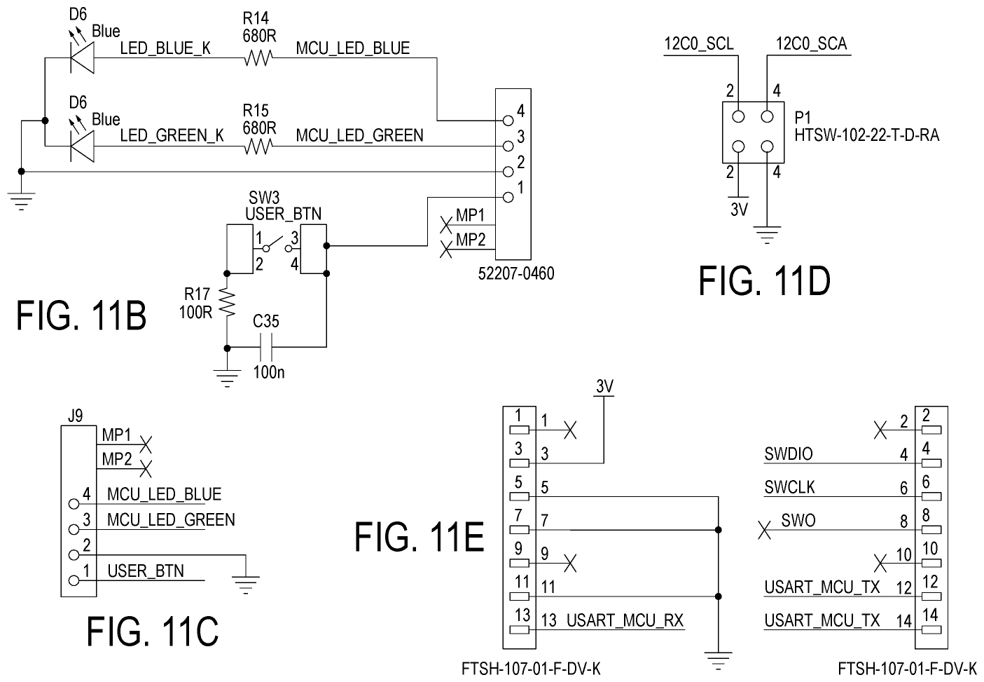

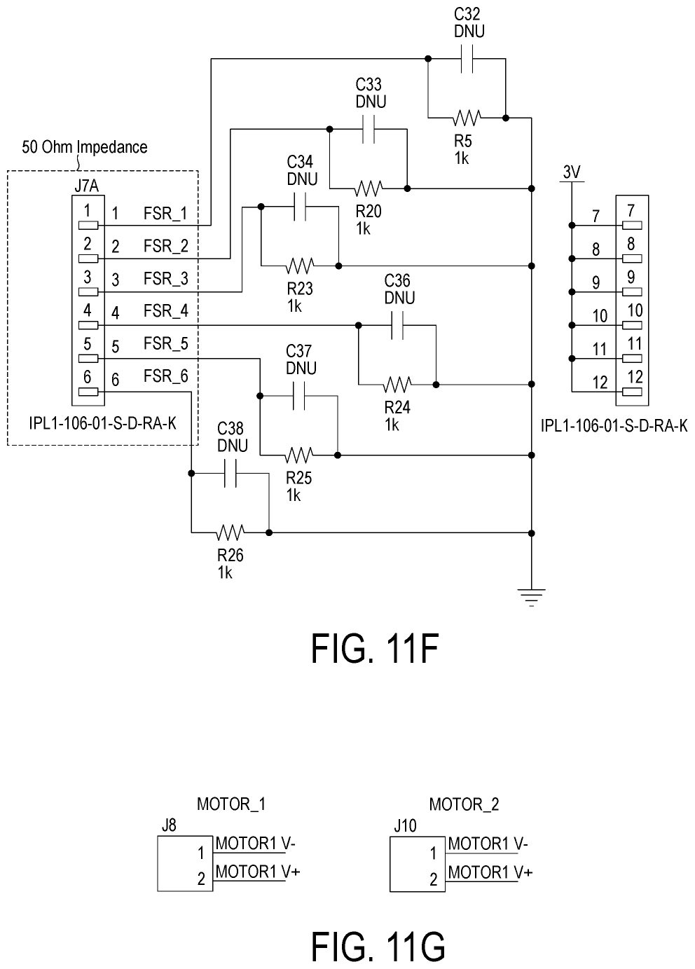

FIG. 11A to FIG. 11G illustrate at least some details of a PCB of at least one example amusement device.

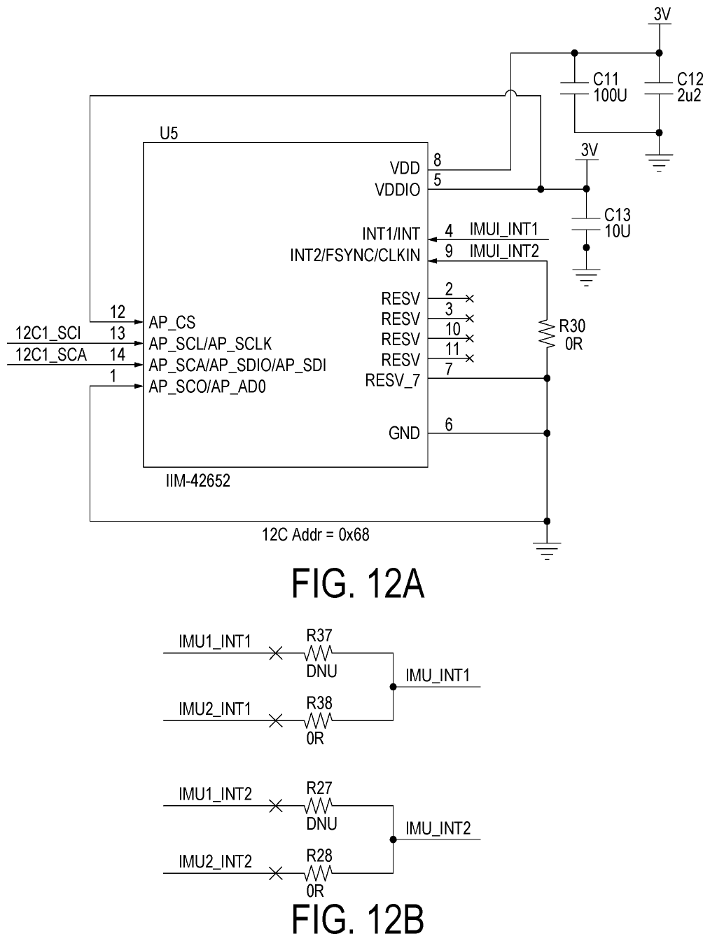

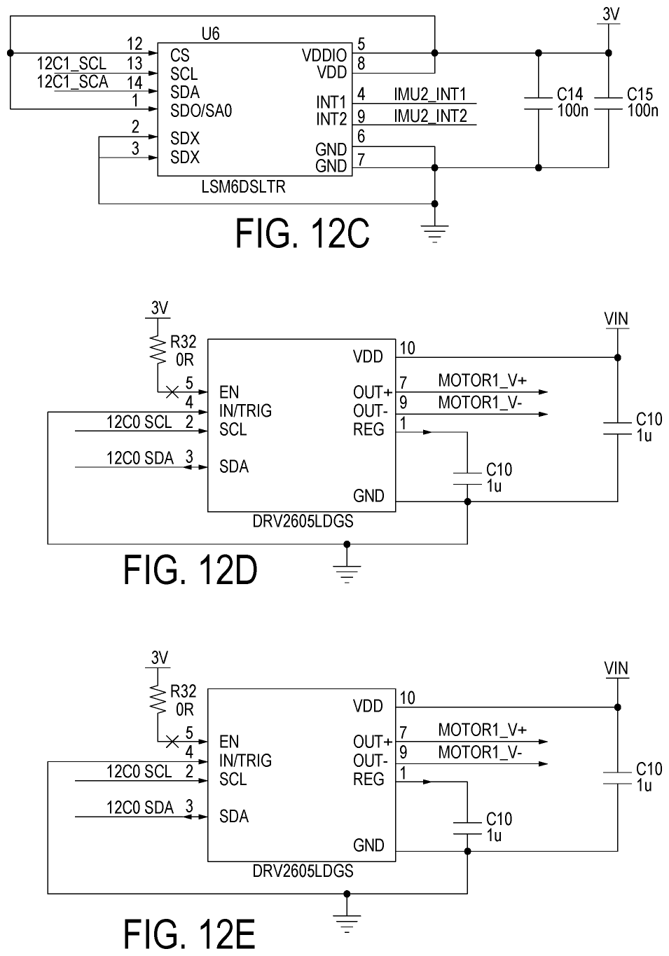

FIG. 12A to FIG. 12E illustrate at least some details of a PCB of at least one example amusement device.

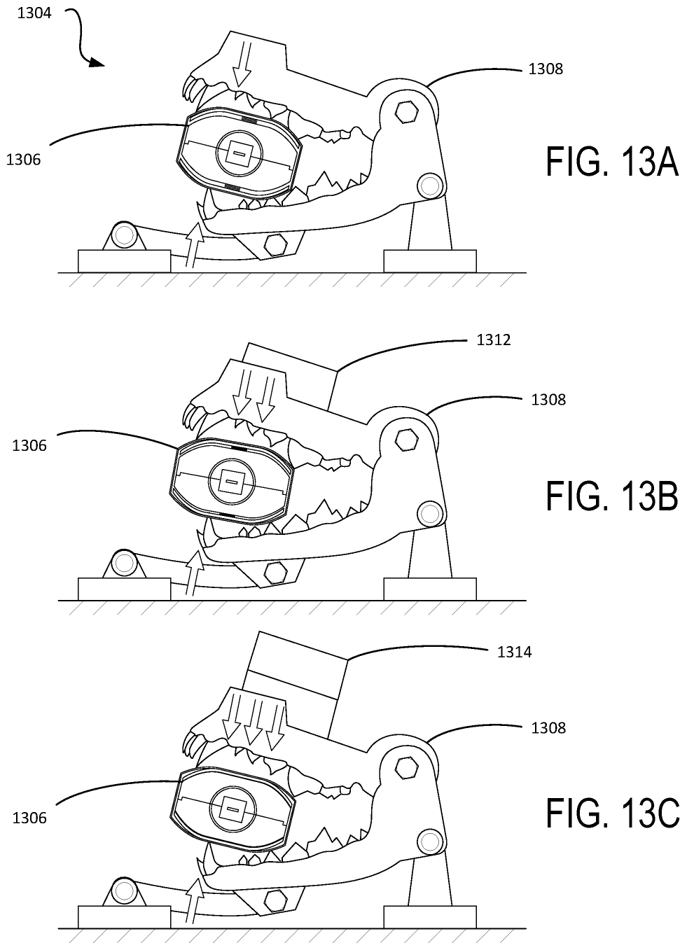

FIG. 13A to FIG. 13C illustrate example testing schemes for pet engagement and/or biteforce measurements with/on an amusement device. In FIG. 13A to FIG. 13C, an animal jaw testing scheme 1304 may be used to test an amusement device 1306 with an animal jaw testing rig 1308. Different testing weights 1312 and/or 1314 may be applied to the rig 1308 to simulate different biteforce input conditions on the amusement device 1306.

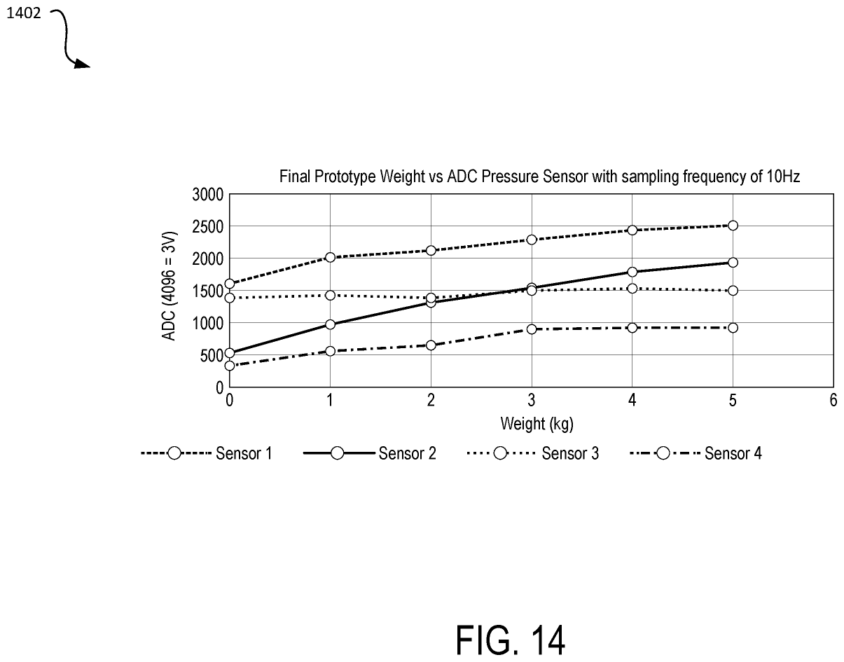

FIG. 14 is an example characteristic 1402 illustrating testing weight/biteforce measurement signals for at least four (4) sensors in a test amusement device (not shown).

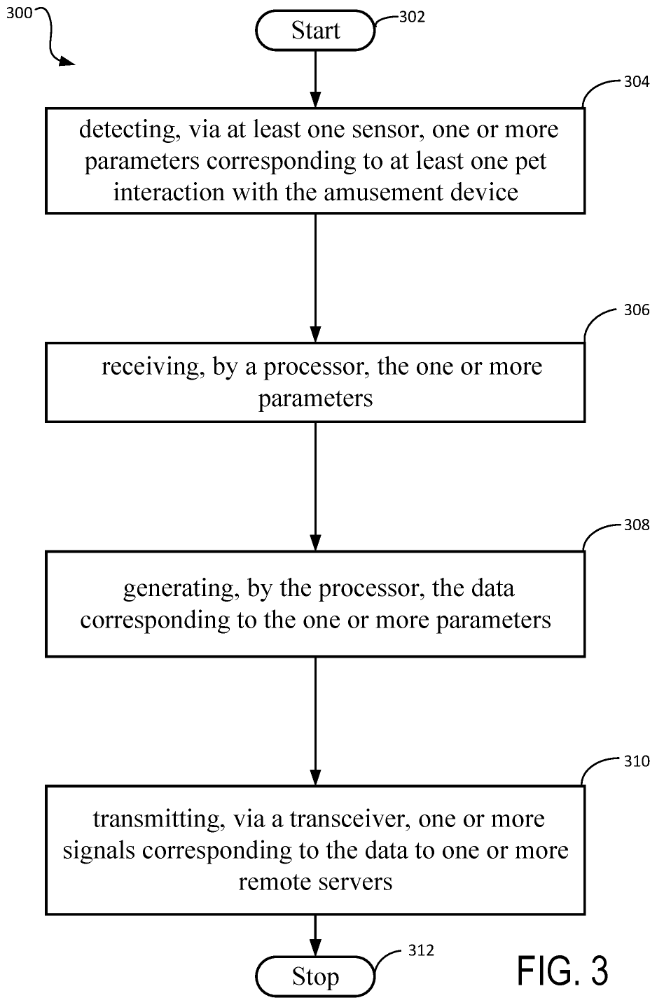

Referring now to FIG. 3, a diagram 300 illustrates an example technique for operating an amusement device via an amusement device communication network. The method may be performed by an amusement device control device (ADCD), that may be installed in the amusement device, among other devices, and/or elsewhere in the amusement device communication network. For example, the amusement device control device may be a process control device/logic controller 110b, among other devices 110a-110d and/or 140a-140i, and/or a cloud computing device. The amusement device control device (ADCD) may be in communication with any of the devices of the Amusement Device Communication System Network (ADCSN) 100. At 302, the process may start or restart.

At 304, an amusement device control device may be configured for detecting, via the at least one sensor, one or more parameters corresponding to at least one pet interaction with the device. At 306, the amusement device control device may be configured for receiving, by the processor, the one or more parameters.

At 308, the amusement device control device may be configured for generating, by the processor, the data corresponding to the one or more parameters. At 310, the amusement device control device may be configured for transmitting, via the transceiver, one or more signals corresponding to the data to one or more remote servers and/or wireless devices (e.g., smartphones). At 312, the process may stop or restart.

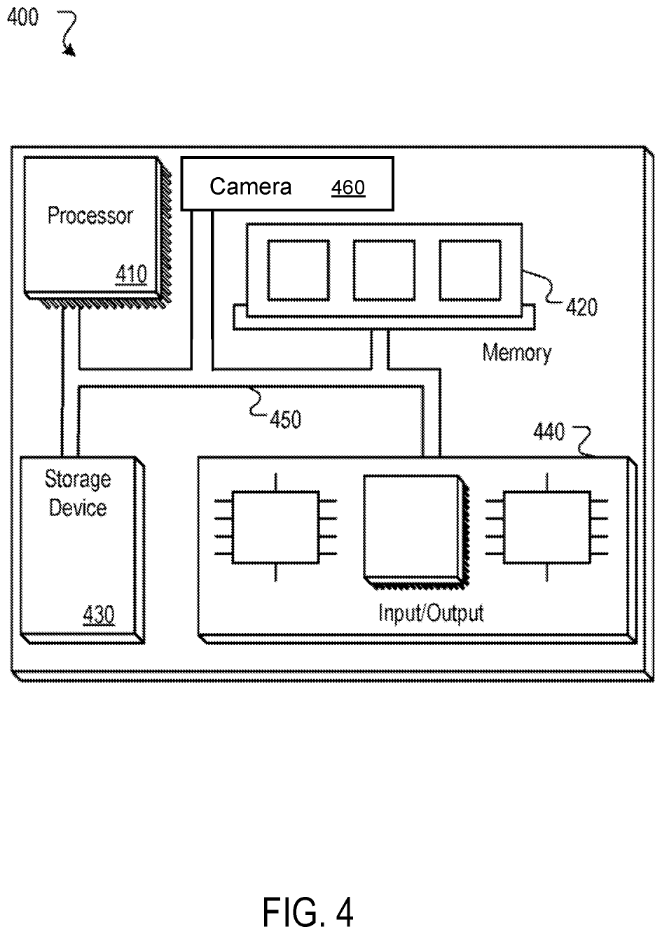

FIG. 4 is a block diagram of a hardware configuration of an example device that may function as a process control device/logic controller, such as the Amusement Device Control Device 110b of FIG. 1, among other devices such as 140a-140i, and any of the devices 110a-110d, for example. The hardware configuration 400 may be operable to facilitate delivery of information from an internal server of a device. The hardware configuration 400 can include a processor 410, a memory 420, a storage device 430, and/or an input/output device 440. One or more of the components 410, 420, 430, and 440 can, for example, be interconnected using a system bus 450. The processor 410 can process instructions for execution within the hardware configuration 400. The processor 410 can be a single-threaded processor or the processor 410 can be a multi-threaded processor. The processor 410 can be capable of processing instructions stored in the memory 420 and/or on the storage device 430.

The memory 420 can store information within the hardware configuration 400. The memory 420 can be a computer-readable medium (CRM), for example, a non-transitory CRM. The memory 420 can be a volatile memory unit, and/or can be a non-volatile memory unit.

The storage device 430 can be capable of providing mass storage for the hardware configuration 400. The storage device 430 can be a computer-readable medium (CRM), for example, a non-transitory CRM. The storage device 430 can, for example, include a hard disk device, an optical disk device, flash memory and/or some other large capacity storage device. The storage device 430 can be a device external to the hardware configuration 400.

The input/output device 440 may provide input/output operations for the hardware configuration 400. The input/output device 440 (e.g., a transceiver device) can include one or more of a network interface device (e.g., an Ethernet card), a serial communication device (e.g., an RS-232 port), one or more universal serial bus (USB) interfaces (e.g., a USB 2.0 port) and/or a wireless interface device (e.g., an 802.11 card). The input/output device can include driver devices configured to send communications to, and/or receive communications from one or more networks (e.g., Amusement Device Communication Network 130 of FIG. 1). The input/output device 400 may be in communication with one or more input/output modules (not shown) that may be proximate to the hardware configuration 400 and/or may be remote from the hardware configuration 400. The one or more output modules may provide input/output functionality in the digital signal form, discrete signal form, TTL form, analog signal form, serial communication protocol, fieldbus protocol communication and/or other open or proprietary communication protocol, and/or the like.

The camera device 460 may provide digital video input/output capability for the hardware configuration 400. The camera device 460 may communicate with any of the elements of the hardware configuration 400, perhaps for example via system bus 450. The camera device 460 may capture digital images and/or may scan images of various kinds, such as Universal Product Code (UPC) codes and/or Quick Response (QR) codes, for example, among other images as described herein. In one or more scenarios, the camera device 460 may be the same and/or substantially similar to any of the other camera devices described herein.

The camera device 460 may include at least one microphone device and/or at least one speaker device (not shown). The input/output of the camera device 460 may include audio signals/packets/components, perhaps for example separate/separable from, or in some (e.g., separable) combination with, the video signals/packets/components the camera device 460.

The camera device 460 may also detect the presence of one or more subjects that may be proximate to the camera device 460 and/or may be in the same general space (e.g., the same room, delimited area, etc.) as the camera device 460. The camera device 460 may gauge a general activity level (e.g., high activity, medium activity, and/or low activity) of one or more subjects that may be detected by the camera device 460. The camera device 460 may detect one or more general characteristics (e.g., height, body shape, skin color, pulse, heart rate, breathing count, etc.) of the one or more subjects detected by the camera device 460. The camera device 460 may be configured to recognize one or more specific subjects, for example.

The camera device 460 may be in wired and/or wireless communication with the hardware configuration 400. In one or more scenarios, the camera device 460 may be external to the hardware configuration 400. In one or more scenarios, the camera device 460 may be internal to the hardware configuration 400.

In view of the descriptions provided herein, the skilled artisan can contemplate and implement a pet amusement device that may comprise at least one housing. The at least one housing may comprise, a memory, a power source, a transceiver, and/or at least one sensor. The at least one sensor may be configured to detect one or more parameters corresponding to at least one pet interaction with the device. The device may comprise at least one processor. The processor may be configured to receive the one or more parameters. The processor may be configured to generate data corresponding to the one or more parameters. The processor may be configured to transmit one or more signals corresponding to the data to one or more remote servers and/or wireless devices (e.g., smartphones).

The device may comprise at least one haptic motor configured to generate at least some vibration through the at least one housing. The processor may be configured to control the at least some vibration based on an occurrence of a predetermined condition, or a command from the one or more remote servers and/or wireless devices (e.g., smartphones). For example, a predetermined condition may include reaching or exceeding a biteforce threshold and/or an engagement time threshold, among other variables.

The at least one sensor may comprise a camera configured to perform ultra-violet (UV) light spectroscopy on the pet. The at least one sensor may comprise an amperometric hydrogen sulfide sensor configured to detect a halitosis condition in the pet. The at least one sensor may comprise a pressure sensor, and/or a temperature sensor.

The at least one housing may comprise a water-resistant rubber, and/or a rubber-like material, silicon, and/or soft plastic. The at least one sensor may comprise an accelerometer, a gyroscope, a proximity beacon, a pH meter, various type of camera devices, and/or a pressure or force sensor. The at least one housing may comprise a clock, a Wi-Fi™ antenna, a cellular antenna, and/or a Bluetooth™ antenna.

The at least one pet interaction device may comprise play with the device, a breathing on the device, a vocalization proximate to the device, a contact with the device, and/or one or more bites on the device, among other interactions and/or measurements of pet characteristics.

The processor may be configured to process the data from the at least one sensor with one or more algorithms and/or models stored in the memory to determine a time of one or more interactions, a frequency of one or more interactions, a duration of one or more interactions, a type of one or more interactions, a bite force of one or more interactions, a bite evenness of one or more interactions, a pH of the pet, blood health of the pet, a temperature of the pet, oral health of the pet, cognitive health of the pet, emotional health or well-being of the pet, a behavior of the pet, a life stage of the pet, seasonality or circadian rhythms of the pet, a location of the one or more interactions, excessive movement or vocal whining of the pet, at least one unique characteristic of the one or more interactions, and/or an identity of the pet. Information about a geographic location, a pet's mobility, and/or a pet's training may be provided.

The processor may be configured to generate the data from the at least one sensor such that the one or more remote servers and/or wireless devices (e.g., smartphones) may process the data with one or more algorithms and/or models stored in a server memory to determine a time of one or more interactions, a frequency of one or more interactions, a duration of one or more interactions, a type of one or more interactions, a bite force of one or more interactions, a bite evenness of one or more interactions, a pH of the pet, blood health of the pet, a temperature of the pet, oral health of the pet, cognitive health of the pet, emotional health or well-being of the pet, a behavior of the pet, a life stage of the pet, seasonality or circadian rhythms of the pet, a location of the one or more interactions, excessive movement or vocal whining of the pet, at least one unique characteristic of the one or more interactions, and/or an identity of the pet. Information about a geographic location, a pet's mobility, and/or a pet's training may be provided.

The at least one housing may be a first housing. The device may comprise a second housing. The second housing may be configured to couple to, enclose, and/or be enclosed by, the first housing. The second housing may comprise a second sensor that is different from the at least one sensor, an antenna that is different from any antenna in the first housing, and/or other component that is different from the at least one sensor, antenna, or other component in the first housing.

The transceiver may be configured to wirelessly transmit the data to the one or more remote servers and/or wireless devices (e.g., smartphones). The device may comprise at least one charging port operably coupled to the power source. The device may comprise at least one data port operably coupled to the processor.

While the inventions have been described with respect to specific examples including presently preferred modes of carrying out the inventions, those skilled in the art will appreciate that there are numerous variations and permutations of the above described systems and techniques. It is to be understood that other embodiments may be utilized and structural and functional modifications may be made without departing from the scope of the present inventions. Thus, the spirit and scope of the inventions should be construed broadly as set forth in the appended claims.

The subject matter of this disclosure, and components thereof, can be realized by instructions that upon execution cause one or more processing devices to carry out the processes and/or functions described herein. Such instructions can, for example, comprise interpreted instructions, such as script instructions, e.g., JavaScript or ECMAScript instructions, or executable code, and/or other instructions stored in a computer readable medium. C++, C#, and/or C, Python scripts and/or Zephyr RTOS may be used.

Implementations of the subject matter and/or the functional operations described in this specification and/or the accompanying figures can be provided in digital electronic circuitry, in computer software, firmware, and/or hardware, including the structures disclosed in this specification and their structural equivalents, and/or in combinations of one or more of them. The subject matter described in this specification can be implemented as one or more computer program products, e.g., one or more modules of computer program instructions encoded on a tangible program carrier for execution by, and/or to control the operation of, data processing apparatus.

A computer program (also known as a program, software, software application, script, or code) can be written in any form of programming language, including compiled or interpreted languages, and/or declarative or procedural languages. It can be deployed in any form, including as a stand-alone program or as a module, component, subroutine, and/or other unit suitable for use in a computing environment. A computer program may or might not correspond to a file in a file system. A program can be stored in a portion of a file that holds other programs and/or data (e.g., one or more scripts stored in a markup language document), in a single file dedicated to the program in question, and/or in multiple coordinated files (e.g., files that store one or more modules, sub programs, or portions of code). A computer program can be deployed to be executed on one computer or on multiple computers that may be located at one site or distributed across multiple sites and/or interconnected by a communication network.

The processes and/or logic flows described in this specification and/or in the accompanying figures may be performed by one or more programmable processors executing one or more computer programs to perform functions by operating on input data and/or generating output, thereby tying the process to a particular machine (e.g., a machine programmed to perform the processes described herein). The processes and/or logic flows can also be performed by, and apparatus can also be implemented as, special purpose logic circuitry, e.g., an FPGA (field programmable gate array) and/or an ASIC (application specific integrated circuit).

Computer readable media suitable for storing computer program instructions and/or data may include all forms of non-volatile memory, media and memory devices, including by way of example semiconductor memory devices (e.g., EPROM, EEPROM, and/or flash memory devices); magnetic disks (e.g., internal hard disks or removable disks); magneto optical disks; and/or CD ROM and DVD ROM disks. The processor and/or the memory can be supplemented by, or incorporated in, special purpose logic circuitry.

While this specification and the accompanying figures contain many specific implementation details, these should not be construed as limitations on the scope of any invention and/or of what may be claimed, but rather as descriptions of features that may be specific to described example implementations. Certain features that are described in this specification in the context of separate implementations can also be implemented in combination in perhaps one implementation. Various features that are described in the context of perhaps one implementation can also be implemented in multiple combinations separately or in any suitable sub-combination. Although features may be described above as acting in certain combinations and/or perhaps even (e.g., initially) claimed as such, one or more features from a claimed combination can in some cases be excised from the combination. The claimed combination may be directed to a sub-combination and/or variation of a sub-combination.

While operations may be depicted in the drawings in an order, this should not be understood as requiring that such operations be performed in the particular order shown and/or in sequential order, and/or that all illustrated operations be performed, to achieve useful outcomes. The described program components and/or systems can generally be integrated together in a single software product and/or packaged into multiple software products.

Examples of the subject matter described in this specification have been described. The actions recited in the claims can be performed in a different order and still achieve useful outcomes, unless expressly noted otherwise. For example, the processes depicted in the accompanying figures do not require the particular order shown, and/or sequential order, to achieve useful outcomes. Multitasking and parallel processing may be advantageous in one or more scenarios.

While the present disclosure has been illustrated and described in detail in the drawings and foregoing description, the same is to be considered as illustrative and not restrictive in character, it being understood that only certain examples have been shown and described, and that all changes and modifications that come within the spirit of the present disclosure are desired to be protected.

1-25. (canceled)

26. A pet amusement device, comprising:
at least one housing comprising, at least in part:
a memory;
a power source;
a transceiver;
at least one sensor, the at least one sensor configured to detect one or more parameters corresponding to at least one pet interaction with the device; and
a processor, the processor configured at least to:
receive the one or more parameters;
generate data corresponding to the one or more parameters; and
transmit one or more signals corresponding to the data to one or more remote servers.

27. The device according to claim 26, wherein the device further comprises:
at least one haptic motor configured to generate at least some vibration through the at least one housing, wherein the processor is further configured to:
control the at least some vibration based on at least one of: an occurrence of a predetermined condition, or a command from the one or more remote servers.

28. The device according to claim 26, wherein the at least one sensor comprises a camera configured to perform at least one of: ultra-violet (UV) light spectroscopy on the pet, visual identification of the pet, or infrared imaging of the pet.

29. The device according to claim 26, wherein the at least one sensor further comprises at least one of: an amperometric hydrogen sulfide sensor configured to detect a halitosis condition in the pet, a pressure sensor, or a temperature sensor.

30. The device according to claim 26, wherein the at least one housing comprises at least one of: a water-resistant rubber, a rubber-like material, silicon, or soft plastic.

31. The device according to claim 26, wherein the at least one sensor comprises at least one of: an accelerometer, a gyroscope, a proximity beacon, a pH meter, or a pressure or force sensor.

32. The device according to claim 26, wherein the at least one housing further comprises at least one of: a clock, a Wi-Fi antenna, a cellular antenna, or a Bluetooth antenna.

33. The device according to claim 26, wherein the at least one pet interaction comprises at least one of: play with the device, a breathing on the device, a proximity to the device, a vocalization proximate to the device, a contact with the device, or one or more bites on the device.

34. The device according to claim 33, wherein the processor is further configured to:
process the data from the at least one sensor with one or more algorithms stored in the memory to determine at least one of: a time of one or more interactions, a frequency of one or more interactions, a duration of one or more interactions, a type of one or more interactions, a bite force of one or more interactions, a bite evenness of one or more interactions, a pH of the pet, blood health of the pet, a temperature of the pet, oral health of the pet, cognitive health of the pet, emotional health or well-being of the pet, a behavior of the pet, a life stage of the pet, seasonality or circadian rhythms of the pet, a location of the one or more interactions, excessive movement or vocal whining of the pet, at least one unique characteristic of the one or more interactions, a geographic location, an indication of pet mobility, an indication of pet training, intervals between sensor signals, duration of time over which sensor signals are captured, a time of day, a calendar date, or an identity of the pet.

35. The device according to claim 33, wherein the processor is further configured to:
generate the data from the at least one sensor such that the one or more remote servers process the data with one or more algorithms stored in a server memory to determine at least one of: a time of one or more interactions, a frequency of one or more interactions, a duration of one or more interactions, a type of one or more interactions, a bite force of one or more interactions, a bite evenness of one or more interactions, a pH of the pet, blood health of the pet, a temperature of the pet, oral health of the pet, cognitive health of the pet, emotional health or well-being of the pet, a behavior of the pet, a life stage of the pet, seasonality or circadian rhythms of the pet, a location of the one or more interactions, excessive movement or vocal whining of the pet, at least one unique characteristic of the one or more interactions, an indication of pet mobility, an indication of pet training, intervals between sensor signals, duration of time over which sensor signals are captured, a time of day, a calendar date, or an identity of the pet.

36. The device according to claim 26, wherein the at least one housing is a first housing, the device further comprising:
a second housing, the second housing configured to couple to the first housing, the second housing comprising at least one of: a second sensor that is different from the at least one sensor, an antenna that is different from any antenna in the first housing, or other component that is different from the at least one sensor, antenna, or other component in the first housing.

37. The device according to claim 26, further comprising at least one of:
at least one charging port operably coupled to the power source; or
at least one data port operably coupled to the processor.

38. A method of operating a pet amusement device, the device comprising:
at least one housing comprising, at least in part:
a memory;
a power source;
a transceiver;
a processor; and
at least one sensor, the method comprising:
detecting, via the at least one sensor, one or more parameters corresponding to at least one pet interaction with the device;
receiving, by the processor, the one or more parameters;
generating, by the processor, the data corresponding to the one or more parameters; and
transmitting, via the transceiver, one or more signals corresponding to the data to one or more remote servers.

39. The method according to claim 38, wherein the device further comprises:
at least one haptic motor configured to generate at least some vibration through the at least one housing, the method further comprising:
controlling the at least some vibration based on at least one of: an occurrence of a predetermined condition, or a command from the one or more remote servers.

40. The method according to claim 38, wherein the at least one sensor comprises at least one of: a camera, or an amperometric hydrogen sulfide sensor, the method further comprising at least one of:
performing, via the camera, ultra-violet (UV) light spectroscopy on the pet; or
detecting, via the sulfide sensor, a halitosis condition in the pet.

41. The method according to claim 38, wherein the at least one pet interaction comprises at least one of: play with the device, a breathing on the device, a proximity to the device, a vocalization proximate to the device, a contact with the device, or one or more bites on the device.

42. The method according to claim 41, further comprising:
processing the data from the at least one sensor with one or more algorithms stored in the memory; and
determining, via the processing, at least one of: a time of one or more interactions, a frequency of one or more interactions, a duration of one or more interactions, a type of one or more interactions, a bite force of one or more interactions, a bite evenness of one or more interactions, a pH of the pet, blood health of the pet, a temperature of the pet, oral health of the pet, cognitive health of the pet, emotional health or well-being of the pet, a behavior of the pet, a life stage of the pet, seasonality or circadian rhythms of the pet, a location of the one or more interactions, excessive movement or vocal whining of the pet, at least one unique characteristic of the one or more interactions, intervals between sensor signals, duration of time over which sensor signals are captured, a time of day, a calendar date, or an identity of the pet.

43. The method according to claim 41, further comprising:
generating, via the processor, the data from the at least one sensor to enable processing of the data by the one or more remote servers with one or more algorithms stored in a server memory for determining at least one of: a time of one or more interactions, a frequency of one or more interactions, a duration of one or more interactions, a type of one or more interactions, a bite force of one or more interactions, a bite evenness of one or more interactions, a pH of the pet, blood health of the pet, a temperature of the pet, oral health of the pet, cognitive health of the pet, emotional health or well-being of the pet, a behavior of the pet, a life stage of the pet, seasonality or circadian rhythms of the pet, a location of the one or more interactions, excessive movement or vocal whining of the pet, at least one unique characteristic of the one or more interactions, intervals between sensor signals, duration of time over which sensor signals are captured, a time of day, a calendar date, or an identity of the pet.

44. The method according to claim 38, wherein the device further comprises at least one of: a charging port, or a data port, the method further comprising at least one of:
charging the power source via the charging port; or
communicating with the processor via the data port.

45. The method according to claim 38, further comprising wirelessly transmitting, via the transceiver, the data to the one or more remote servers.
